(19) United States
(12) Patent Application Publication
(10) Pub. No.: US 2011/0000350 A1
(43) Pub. Date: Jan. 6, 2011

(54) MACHINE FOR CUTTING HIDES AND THE LIKE AND SHEET-LIKE MATERIALS IN GENERAL, WITH SIMPLIFIED-ACCESS WORKTABLE

(75) Inventor: Alessandro Zorzolo, Vigevano (IT)

Correspondence Address: SCULLY SCOTT MURPHY & PRESSER, PC, 400 GARDEN CITY PLAZA, SUITE 300, GARDEN CITY, NY, 11530, US

(73) Assignee: COMELZ S.P.A., Vigevano (IT)

(21) Appl. No.: 12/918,900

(22) PCT Filed: Feb. 3, 2009
(86) PCT No.: PCT/EP2009/051179

§ 371 Date: Aug. 23, 2010

(30) Foreign Application Priority Data
Feb. 22, 2008 (IT) MI2008A000286

(51) Int. Cl. B26D 5/02; B26D 3/10; B26D 7/01; B26D 1/00; B26F 3/00; B23K 26/38

(52) U.S. Cl. 83/76.6; 83/648; 83/523; 83/100; 83/597; 83/177; 219/121.67; 409/80

(57) ABSTRACT

A machine for cutting hides and the like and sheet-like material in general, with simplified-access worktable, comprising a footing for supporting a worktable, and cutting elements adapted to be moved on said worktable along the contours of the shapes to be cut, by way of numeric control, wherein the imaginary extensions of three sides of said worktable do not encounter obstacles due to said cutting elements and supports thereof, the fourth side of the worktable being surmounted by a cantilever arm that supports said cutting elements.

### TECHNICAL FIELD

The present invention relates to a machine for cutting hides and the like and sheet-like materials in general, with simplified-access cutting table. More particularly, the invention relates to a hide cutting machine with a cutting table adapted to accommodate hides whose dimensions exceed said cutting table in each of the four sides of the cutting table.

### BACKGROUND ART

As is known, numeric-control cutting machines provided with an X-Y moving carriage and a fixed worktable with suction are currently used to cut hides. These machines have a worktable that is adapted to process hides by successive portions thereof, thus performing the cutting operations successively on limited portions of the hides due to the dimensions of the worktable.

The dimensions of the worktable or cutting area are in fact depending on the characteristics of the bridge cranes and by the need of the operator for visibility during the operation for placement of the hides on the area or worktable.

Substantially, cutting machines with a fixed worktable with suction are divided into single-station machines and oscillating two-station machines.

Whereas in single-station machines the operations of the operator (placement of the hides and unloading thereof) and of the cutting heads are performed sequentially, in the configuration with double oscillating station the operator and the cutting head alternate between the two stations in order to perform the operations in parallel.

The width of each station is adapted to accommodate a statistically significant portion of the hides, as regards the width of the hide, while the depth of the area or worktable of the station is limited by the need for the operator to have visibility for the placement of the hide and therefore can contain only successive portions of the hides that are made to slide sequentially along the longitudinal direction.

Cutting on the hides is performed by a tool carriage, which slides in the direction of the depth of the worktable along a bridge that is moved along the transverse direction, i.e., the direction of the width of the worktable.

While the front portion of the bridge runs on a guide arranged along the front transverse side of the worktable, i.e., the width side of the worktable, at the rear the bridge surmounts a containment pocket, which allows to accommodate the portion of hide yet to be worked, rolled up onto itself.

This allows to position and work on the worktable or work area hides whose width is comprised within the maximum width of the workstation and whose length is greater than the length of the working field, since the excess portion can be rolled up on itself rolled onto itself and be accommodated in the containment pocket.

However, it is not possible to make the excess of hide to protrude at the front due to the presence of the front guide of the bridge crane.

### DISCLOSURE OF THE INVENTION

The aim of the present invention is to provide a machine for cutting hides and the like and sheet-like materials in general with simplified-access worktable, which allows to work hides whose dimensions exceed the work area in each of the four sides of the worktable or work area.

Within this aim, an object of the present invention is to provide a hide cutting machine with simplified-accessibility worktable that allows to work even exclusively central portions of the hide, with the hide protruding at the front with respect to the worktable, as well as from both sides of said worktable, and to the rear.

Another object of the present invention is to provide a hide cutting machine that is highly reliable, relatively simple to provide and at competitive costs.

This aim, as well as these and other objects that will become better apparent hereinafter, are achieved by a machine for cutting hides and the like and sheet-like material in general, with simplified-access worktable, comprising a footing for supporting a worktable, and cutting elements adapted to be moved on said worktable along the contours of the shapes to be cut, by means of numeric control, characterized in that the imaginary extensions of three sides of said worktable do not encounter obstacles due to said cutting elements and their supports, the fourth side of the worktable being surmounted by a cantilever arm that supports said cutting elements.

### BRIEF DESCRIPTION OF THE DRAWINGS

Further characteristics and advantages of the invention will become better apparent from the description of preferred but not exclusive embodiments of the machine according to the invention, illustrated by way of non-limiting example in the accompanying drawings, wherein:

FIG. 1 is a perspective view of a hide cutting machine according to the present invention;

FIG. 2 is a side elevation view of the machine;

FIGS. 3 and 4 are views, in two operating positions, of a solution for moving a portion of the machine according to the invention.

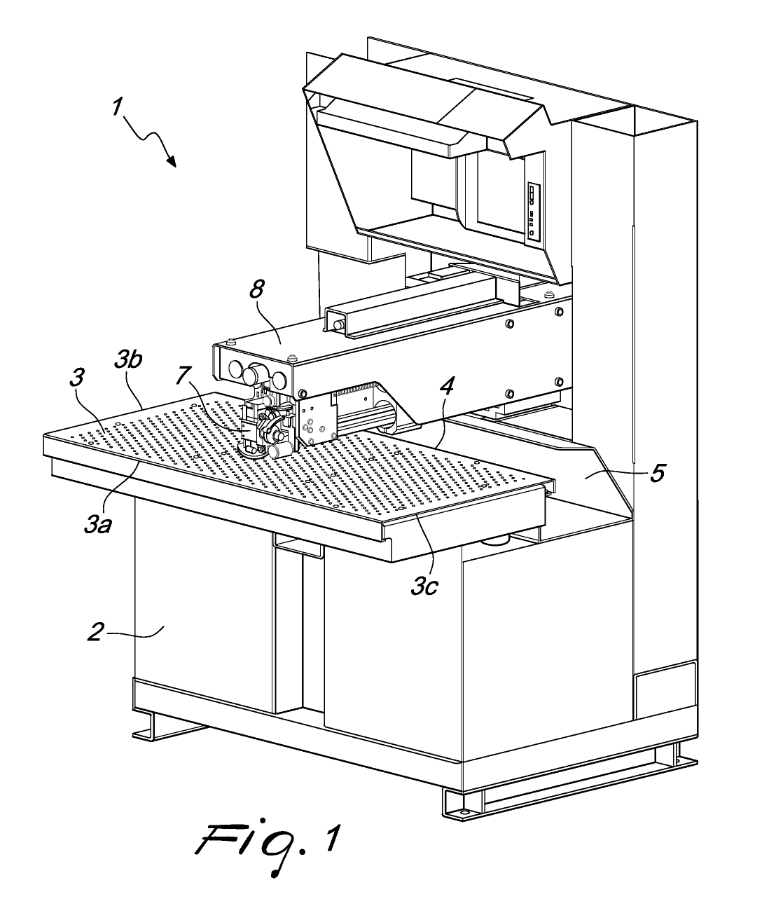

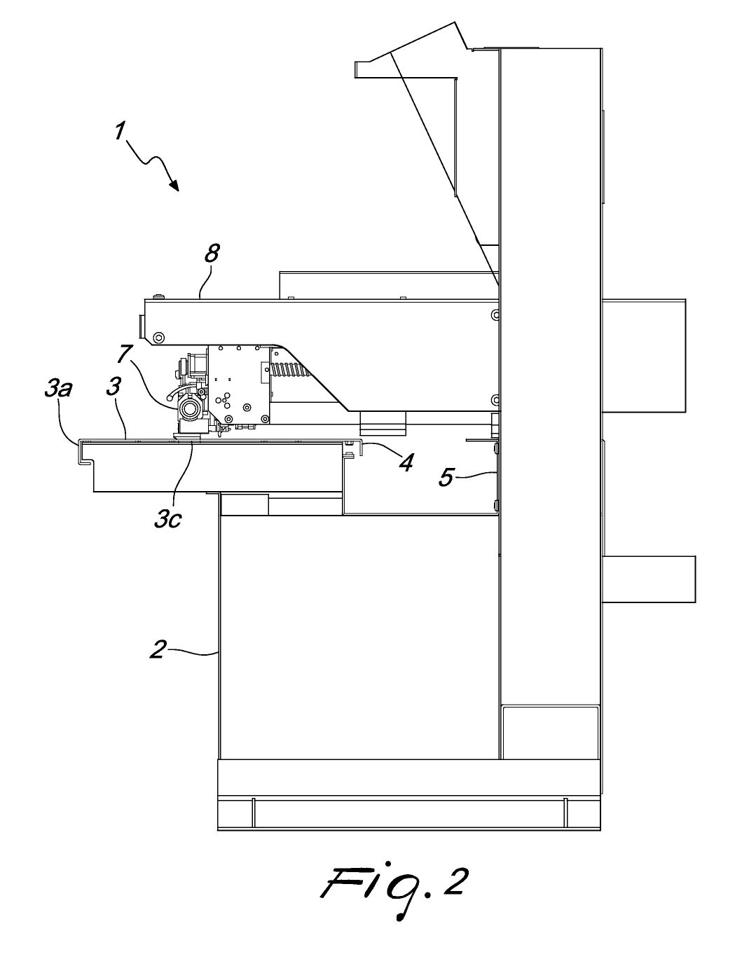

### WAYS OF CARRYING OUT THE INVENTION

With reference to the figures, the hide cutting machine according to the present invention, generally designated by the reference numeral 1, comprises a supporting footing 2, which is adapted to support a worktable 3, which is conveniently free on three sides, i.e., the long side 3a, which the operator faces, and the corresponding two opposite short sides 3b and 3c.

Substantially, the imaginary extensions of the three sides of the worktable do not encounter obstacles determined by the support and by the actuation of cutting elements, defined hereinafter.

The fourth side of the worktable 3, the side 4, instead faces a pocket 5 for containing the hide being worked, which is rolled up in this pocket in order to be then drawn on to the worktable 3, unrolling it. Therefore, the worktable of the machine according to the invention, differently from the background art, has no obstacles on the imaginary extension of the three sides 3a, 3b and 3c, while the fourth side 4 faces the containment pocket 5.

Conveniently, the machine is provided with cutting elements, conveniently constituted by a cutting head 7 which is supported telescopically at the end of an arm 8 which is fixed in a cantilever manner to the frame of the machine, particularly to the rear portion of the footing of the machine, and cantilevers out on the worktable 3.

Conveniently, the cutting head can move telescopically along the longitudinal axis of the arm 8, and the arm 8 can rotate about its point of pivoting to the frame or footing 2 of the machine.

In this manner, each position of the cutting head 7 in the worktable 3 or work area, instead of being definable by way of Cartesian X and Y coordinates, can be defined with polar coordinates R, i.e., distance from the fulcrum, and α, i.e., the angular position of the arm 8.

Conveniently, as an alternative, the cutting head 7 can be movable along the longitudinal axis of the arm 8, and such arm can be movable transversely to its longitudinal axis, i.e., parallel to the long side 3a and 4 of the worktable 3.

Since the rotating arm 8 fixed in a cantilever fashion has a considerable mass and at the same time must be moved with good accelerations that allow an adequate cutting speed, the torque required for such rotating arm must therefore be supplied by a motor that is coupled an element with a large reduction ratio.

Ordinary gear-type reduction units do not meet this goal, and a solution with pulleys and belts would be inadequate due to the lack of rigidity caused by the elasticity of the belt.

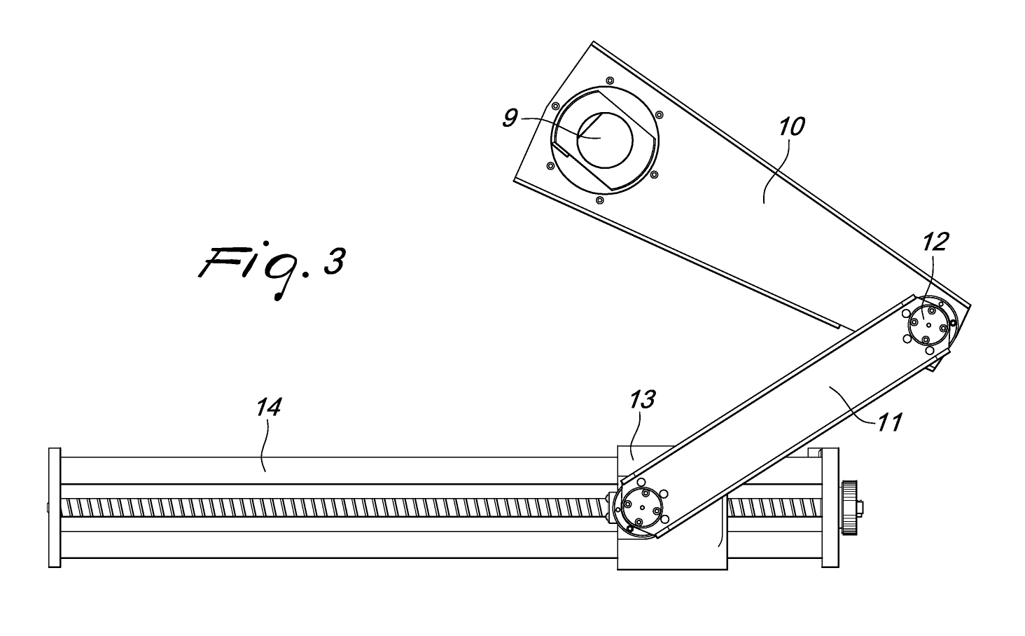

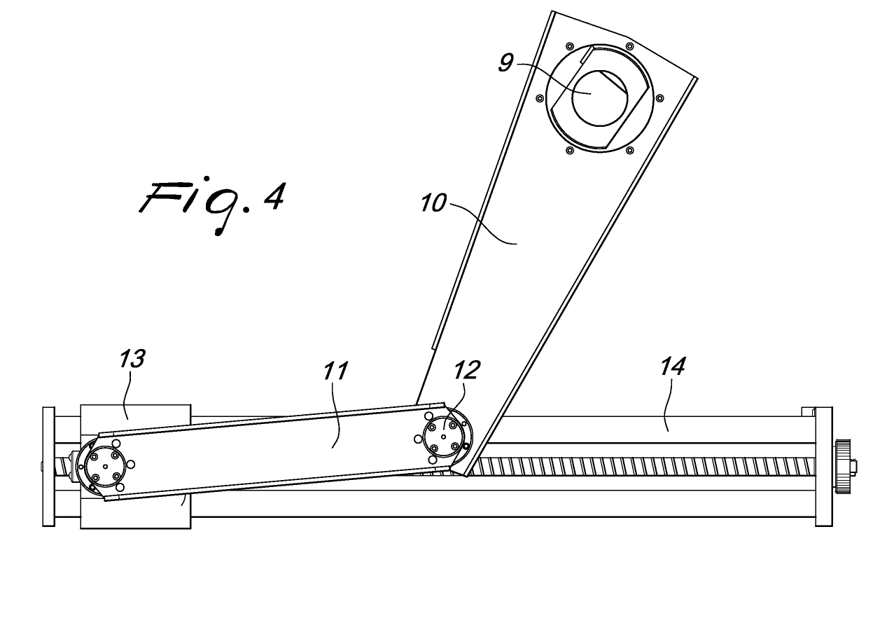

One possible technical solution for rotating the cantilever arm 8, illustrated in FIGS. 3 and 4, might therefore be to have a system of two levers 10 and 11 which are pivoted to each other at a point 12.

The lever 10 is fixed, at its end that lies opposite the pivoting point 12, to a pivot 9 (which constitutes the pivoting point of the arm 8) of the rotating arm 8, while the lever 11 is pivoted, at its end that lies opposite the pivoting point 12, to a carriage 13 that can move in a linear fashion along a pair of guides 14.

Substantially, the linear movement of the carriage 13 along the guides 14 generates a rotation of the pivot 9 to which the rotating arm 8 is fixed, providing for the movement of the carriage 13 and with a high rigidity of the entire assembly.

The rotating arm 8 can be of the telescopic type.

The cutting head 7 can be provided with different cutting means, such as an oscillating blade, a milling cutter, a laser, a water jet and the like.

The machine according to the invention is also provided with means adapted to project onto the worktable the shapes to be cut.

Advantageously, the material to be cut, in the case of use of cutting means constituted by an oscillating blade or milling cutter, is retained on the cutting table 3 by suction.

In practice it has been found that the hide cutting machine according to the present invention fully achieves the intended aim and objects, since it allows to position on the worktable hides of any length and/or width, because said worktable is not limited in its imaginary extensions on three sides, while the fourth side in any case faces the containment pocket that allows to accommodate the excess hide rolled up onto itself.

The machine thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application no. MI2008A000286, from which this application claims priority, are incorporated herein by reference.

1-14. (canceled)

15. A machine for cutting hides and the like and sheet-like material in general, with simplified-access worktable, comprising a footing for supporting a worktable, and cutting elements adapted to be moved on said worktable along the contours of the shapes to be cut, by means of numeric control, wherein the imaginary extensions of three sides of said worktable do not encounter obstacles due to said cutting elements and supports thereof, the fourth side of the worktable being surmounted by a cantilever arm that supports said cutting elements.

16. The machine according to claim 15, wherein said fourth side of said worktable faces a pocket for containing the hide to be worked.

17. The machine according to claim 15, wherein said cutting elements comprise a cutting head that can move along a longitudinal axis of said arm.

18. The machine according to claim 17, wherein said arm is pivoted at the opposite end to the support of said cutting head.

19. The machine according to claim 18, wherein said arm is adapted to rotate about said opposite end on said worktable.

20. The machine according to claim 15, wherein said arm is adapted to perform a translational motion parallel to long sides of said worktable.

21. The machine according to claim 15, wherein said arm is coupled, by means of one pivot, to a first lever, which in turn is pivoted to a second lever, said second lever being pivoted to a carriage that can move along a pair of linear guides, the translational motion of said movable carriage along said guides generating a rotation of said pivot to which said arm is fixed.

22. The machine according to claim 15, wherein said worktable is provided with suction means that are adapted to keep stationary thereon the hide or sheet-like material to be worked.

23. The machine according to claim 17, wherein said arm that supports said cutting head is of the telescopic type.

24. The machine according to claim 17, wherein said cutting head is provided with an oscillating blade.

25. The machine according to claim 17, wherein said cutting head is provided with a milling cutter.

26. The machine according to claim 17, wherein said cutting head is provided with a laser.

27. The machine according to claim 17, wherein said cutting head is adapted to emit a jet of water to perform cutting.

28. The machine according to claim 15, further comprising means adapted to project onto said worktable shapes to be cut.
